(19) United States
(12) Patent Application Publication
(10) Pub. No.: US 2022/0381388 A1
(43) Pub. Date: Dec. 1, 2022

(54) HEATED CHEMICAL TRANSFER HOSE

(71) Applicant: Parker-Hannifin Corporation, Cleveland, OH (US)

(72) Inventor: Steven M. Powell, Chardon, OH (US)

(21) Appl. No.: 17/826,586

(22) Filed: May 27, 2022

Related U.S. Application Data
(60) Provisional application No. 63/194,200, filed on May 28, 2021.

(51) Int. Cl. F16L 53/38; F16L 11/12; F16L 11/08; H05B 3/58

(52) U.S. Cl. CPC F16L 53/38; F16L 11/12; F16L 11/085; H05B 3/58; F16L 2011/047

(57) ABSTRACT

A hose assembly defines a longitudinal axis and includes an inner core tube, a thermal distribution element, and a heating element. The thermal distribution element surrounds the inner core tube, the thermal distribution element including a metalized coated film. The heating element surrounds the inner core tube, the heating element being in thermal contact with the metalized coated film.

### RELATED APPLICATIONS

This application claims the benefit of U.S. Provisional Application No. 63/194,200 filed May 28, 2021, which is incorporated herein by reference.

### FIELD OF INVENTION

The present invention relates to hose assemblies, and more particularly to heated chemical transfer hose assemblies.

### BACKGROUND

Chemical transfer hoses are used to transport chemicals from one location to another. There are many different applications and chemical(s) for which the hose can be used. In some situations, the chemical transfer hose can be used to transport moisture sensitive chemicals. In some situations, the chemical being transported is to be maintained at a particular temperature or within a temperature range.

For example, chemical transfer hoses can be used in the application of spray foam, such as polyurethane foam. In some embodiments, hoses can be used to respectively transport the A and B components of a two-component foam, which is combined at the spray gun and applied to a substrate. One or both of these components can be moisture sensitive chemicals. Also, one or both of these components may be required to be maintained at a particular temperature or within a particular temperature range for combination and application. Introduction of moisture into the line and/or cold spots along the hose can negatively affect the component to be applied. This may result in clogging of the hose and/or issues with the sprayed product.

In another example, chemical transfer hoses can be used to transport glue. Introduction of moisture into the line can negatively affect glue performance. The presence of cold spots along the hose can negatively affect the ability to apply the glue in a desired manner (e.g., spray application), and can even cause the glue to clog the hose.

In some conventional situations, a butyl rubber sleeve is provided over the hose to reduce or prevent moisture permeation. However, this can be labor intensive and add significant cost to the hose construction.

In situations where temperature of the hose and/or chemical(s) transported therein is of consideration, some conventional hoses also include an electrical conductor wire in the hose construction to heat the hose. However, the conductor wire itself may not provide sufficient even heating in the hose. Cold spots or regions can still be present along the hose. Also, in some conventional situations, a foam insulation sleeve can be provided over the hose to insulate the hose. However, this increases the overall size of the assembly and may be unsuitable for different applications.

Accordingly, there is still need for improvement in this technology area.

### SUMMARY OF INVENTION

The present application provides a hose assembly including a thermal distribution element and a heating element. The thermal distribution element improves the thermal distribution of electrical heating throughout the hose in the longitudinal direction. Also, the hose assembly can include a foamed outer hose cover. This can reduce heat loss from the base hose design, which can either eliminate the need for an outer insulation layer to be provided over the hose assembly or dramatically reduce its required thickness.

The present application also provides a hose assembly including a moisture barrier integral with the hose inner core tube. This can eliminate the need for an additional barrier material to be provided over the exterior of the hose.

According to an aspect of the present disclosure, a hose assembly defines a longitudinal axis and includes: an inner core tube; a thermal distribution element surrounding the inner core tube, the thermal distribution element including a metalized coated film; and a heating element surrounding the inner core tube, the heating element in thermal contact with the metalized coated film.

In some embodiments, the heating element surrounds the thermal distribution element.

In some embodiments, the thermal distribution element surrounds the heating element.

In some embodiments, the hose assembly further includes a moisture barrier layer surrounding the inner core tube, wherein the thermal distribution element and the heating element surround the moisture barrier layer. In some embodiments, the hollow tubular core includes a polyamide. In some embodiments, the moisture barrier layer includes a polyolefin. In some embodiments, the moisture barrier layer includes a polyolefin modified with maleic anhydride. In some embodiments, the moisture barrier layer includes more than one layer.

In some embodiments, the hose assembly further includes a reinforcement layer surrounding the inner core tube, the reinforcement layer formed of a braid of strands. In some embodiments, the hose assembly further includes an inner core layer surrounding the reinforcement layer.

In some embodiments, the metalized coated film is helically wound along the longitudinal axis.

In some embodiments, the metalized coated film is helically wound at a pitch angle of 30° to 75° relative to the longitudinal axis.

In some embodiments, the metalized coated film includes a substrate and a metal coating on a surface of the substrate. In some embodiments, the metalized coated film includes an adhesive.

In some embodiments, the heating element includes a wire, wherein the heating element is helically wound along the longitudinal axis.

In some embodiments, the hose assembly further includes an insulation layer surrounding the thermal distribution element and the heating element, wherein the insulation layer includes an insulation film helically wound along the longitudinal axis. In some embodiments, the insulation film includes metallic film.

In some embodiments, the hose assembly further includes a cover layer surrounding the thermal distribution element and the heating element. In some embodiments, the cover layer is a foamed material.

In some embodiments, the hose assembly further includes a fluoropolymer inner layer, wherein the inner core tube surrounds the fluoropolymer inner layer.

The foregoing and other features of the invention are hereinafter described in greater detail with reference to the accompanying drawings.

Other systems, devices, methods, features, and advantages of the present invention will be or become apparent to one having ordinary skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWING

FIG. 1 is a schematic drawing of a perspective view of a hose assembly according to an embodiment of the present application.

FIG. 2 is a schematic cross-sectional view of the hose assembly shown in FIG. 1 as viewed along the longitudinal axis L of the hose assembly.

FIG. 3 is a schematic drawing of a perspective view of another hose assembly according to an embodiment of the present application.

FIG. 4 is a schematic cross-sectional view of the hose assembly shown in FIG. 3 as viewed along the longitudinal axis L of the hose assembly.

FIG. 5 is a schematic drawing of a perspective view of another hose assembly according to an embodiment of the present application.

FIG. 6 is a schematic cross-sectional view of the hose assembly shown in FIG. 5 as viewed along the longitudinal axis L of the hose assembly.

FIG. 7 is a schematic drawing of a perspective view of a hose assembly according to an embodiment of the present application.

FIG. 8 is a schematic cross-sectional view of the hose assembly shown in FIG. 7 as viewed along the longitudinal axis L of the hose assembly.

FIG. 9 is a schematic drawing of a perspective view of a hose assembly according to an embodiment of the present application.

FIG. 10 is a schematic cross-sectional view of the hose assembly shown in FIG. 9 as viewed along the longitudinal axis L of the hose assembly.

### DETAILED DESCRIPTION

Aspects of the present disclosure relate to hoses that are suitable for use in various applications. Principles of this present application have particular application to hose assemblies where temperature sensitive chemical is transported in the hose and/or in applications where the fluid transported in the hose is to be maintained at a particular temperature or temperature range. Principles of this present application also have particular application to hose assemblies where moisture sensitive chemical is carried in the hose. Some exemplary applications include delivery of spray foam component. Other exemplary applications include delivery of adhesive. But it will be appreciated that principles of this invention may be applicable to other hose assemblies and applications where it is desirable to provide temperature control and/or moisture control. When used in a suitable application, the hose assembly may be configured for engagement between one or more co-axially arranged metal fittings or other quick connectors.

The hose may be formed of at least an inner core tube, a thermal distribution element, and a heating element. Each of the thermal distribution element and heating element may surround the inner core tube. Depending on the application, the hose assembly may further include a moisture barrier layer, reinforcement layer, inner cover layer, insulation layer, and/or an outer cover layer.

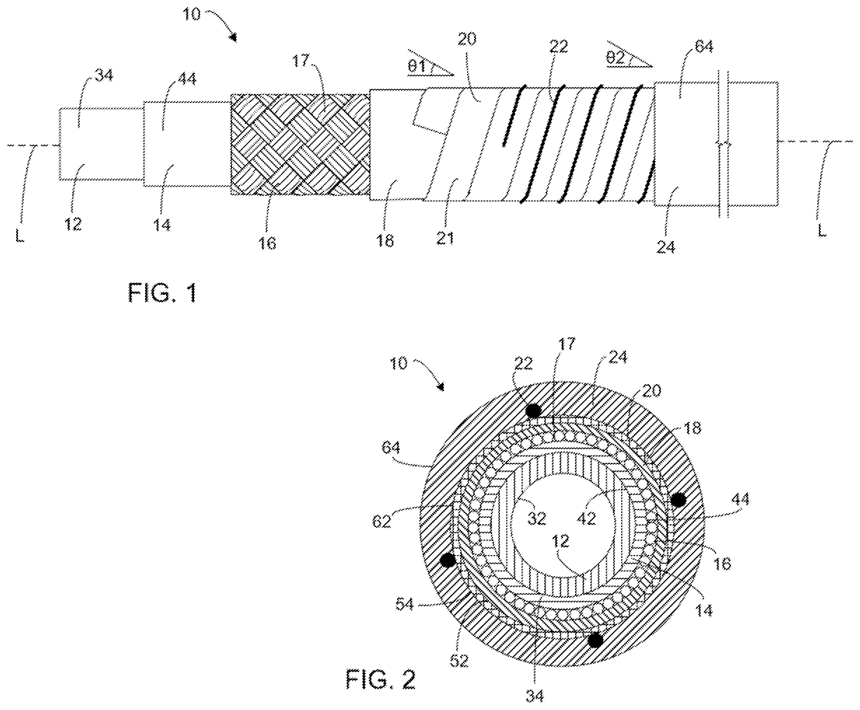

Referring now to FIGS. 1 and 2, an exemplary hose assembly is generally designated by reference numeral 10. The hose assembly may alternatively be referred to as a hose. The hose assembly 10 is constructed as a hollow tubular assembly defining a longitudinal axis L and includes an inner core tube 12, a moisture barrier layer 14, a reinforcement layer 16, an inner cover layer 18, a thermal distribution element 20, a heating element 22, and an outer cover layer 24 that are concentrically arranged. The moisture barrier layer 14 surrounds the inner core tube 12; the reinforcement layer 16 surrounds the moisture barrier layer 14; the inner cover layer 18 surrounds the reinforcement layer 16; the thermal distribution element 20 surrounds the inner cover layer 18; the heating element 22 surrounds the thermal distribution element 20; and the outer cover layer 24 surrounds the heating element 22.

The inner core tube 12 is tubular in shape and configured to receive a fluid for flowing through the inner core tube 12. The inner core tube 12 may be formed of any suitable material. In some embodiments, the inner core tube 12 is a thermoplastic (e.g., melt-processible) material such as a polyamide. Exemplary polyamides include Nylon 6, Nylon 6/66, Nylon 11, Nylon 12, Nylon 1012, Nylon 6/12, or blends thereof. The polyamide (or blend) may be chemically resistant polyamide (or blend) selected for chemical compatibility with the fluid to be flowed through the hose. In other embodiments, the inner core tube 12 is a thermoplastic material such as a polyolefin, polyester, fluoropolymer, polyvinyl chloride, ethylene vinyl alcohol (EVA), polyacetal, polyoxymethylene (POM), silicone, thermoplastic rubber, polyurethane, or blends thereof. Exemplary fluoropolymers include polyvinylfluoride (PVF), polyvinylidene fluoride (PVDF), and polytetrafluoroethylene (PTFE). Exemplary polyolefins polyethylene, polypropylene, and polybutene. In other embodiments, the inner core tube 12 is a vulcanizable (e.g., thermosetting) material natural or synthetic rubber. Examples include SBR, polybutadiene, EPDM, butyl, neoprene, nitrile, polyisoprene, buna-N, copolymer rubber, or blends thereof. One exemplary blend is ethylene-propylene rubber. The material selected may be dependent on the application and for chemical compatibility with the fluid being handled. The material may also be selected based on the operation temperature for a given application. For example, in some embodiments, the fluid in the hose may be provide (or heated in the hose) to up to for service up to 100° C.

In some embodiments, the inner core tube 12 is an extruded material and may be formed by a suitable extrusion process. The inner core tube 12 has an inner surface 32 and an outer surface 34. In some embodiments, the inner surface 32 defines the inner diameter of the hose assembly 10.

The wall of the inner core tube 12 may have any suitable thickness. The thickness is the distance between the inner surface 32 and the outer surface 34 of the inner core tube 12 in a radial direction. In some embodiments, the wall thickness is 0.05 mm to 2 mm. In other embodiments, the wall thickness is 0.5 mm to 1 mm. In other embodiments, the wall thickness is 0.6 mm to 0.9 mm.

Although the inner core tube 12 may be formed of a unitary, single-layer construction, in some embodiments the inner core tube 12 is provided as a composite, multi-layer construction. In an example of such multi-layer construction (not shown), inner core tube 12 includes an innermost layer, which defines the inner surface 32 of the inner core tube, and an outermost layer, which defines the outer surface 34 of the inner core tube. In such embodiments, the layers of the inner core tube may be formed of any suitable material such as those described above. In some embodiments, the material of the layers of the inner core tube are different from one another. In other embodiments, the material of the layers of the inner core tube are the same.

The inner diameter of the hose assembly 10 may be any suitable size, and may depend on the particular application of the hose. In some embodiments, the inner diameter of the hose assembly is in the range of 0.3 cm to 2.54 cm. In other embodiments, the inner diameter of the hose assembly is in the range of 0.3 cm to 1.27.

The moisture barrier layer 14 may provide low moisture permeation. The moisture barrier layer 14 concentrically surrounds the outer surface 34 of the inner core tube 12. The moisture barrier layer 14 extends along at least a portion of the inner core tube 12 along the longitudinal axis L of the hose assembly 10. The moisture barrier layer 14 is configured to reduce or prevent permeation of moisture into the inner core tube 12. The moisture barrier layer 14 may be formed of any suitable material. In some embodiments, the moisture barrier layer 14 is a polyolefin. Exemplary polyolefins polyethylene, polypropylene, and polybutene. In some embodiments, the moisture barrier layer 14 is a polyolefin modified with maleic anhydride. Maleic anhydride may promote bonding of the moisture barrier layer 14 to polyamide, which may be the material of the inner core tube 12. In other embodiments, the moisture barrier layer is a thermoplastic material such as a polyester, fluoropolymer, polyvinyl chloride, ethylene vinyl alcohol (EVA), polyacetal, polyoxymethylene (POM), silicone, thermoplastic rubber, polyurethane, polyamide, or blends thereof. Exemplary fluoropolymers include polyvinylfluoride (PVF), polyvinylidene fluoride (PVDF), and polytetrafluoroethylene (PTFE). In other embodiments, the moisture barrier layer 14 is a vulcanizable (e.g., thermosetting) material natural or synthetic rubber. Examples include SBR, polybutadiene, EPDM, butyl, neoprene, nitrile, polyisoprene, buna-N, copolymer rubber, or blends thereof. In some embodiments, the moisture barrier layer 14 is an extruded material and may be formed by a suitable extrusion process. The moisture barrier layer 14 has an inner surface 42 and an outer surface 44. The wall of the moisture barrier layer 14 may have any suitable thickness (between the inner surface 42 and the outer surface 44). In some embodiments, the wall thickness is 0.05 mm to 2 mm. In other embodiments, the wall thickness is 0.1 mm to 2 mm. In other embodiments, the wall thickness is 0.1 mm to 1 mm.

Although the moisture barrier layer 14 may be formed of a unitary, single-layer construction, in some embodiments the moisture barrier layer 14 is provided as a composite, multi-layer construction. In an example of such multi-layer construction (not shown), moisture barrier layer 14 includes an innermost layer, which defines the inner surface 42 of the moisture barrier layer 14, and an outermost layer, which defines the outer surface 44 of the moisture barrier layer 14. In such embodiments, the layers of the moisture barrier layer 14 may be formed of any suitable material such as those described above. In some embodiments, the material of the layers of the moisture barrier layer 14 are different from one another. In other embodiments, the material of the layers of the moisture barrier layer 14 are the same.

The inner core tube 12 and the moisture barrier layer 14 are bonded to one another and may be considered to be integrally formed with one another. In some embodiments, the inner core tube 12 and the moisture barrier layer are coextruded. In other embodiments, the inner core tube 12 is initially extruded, and the moisture barrier layer 14 is subsequently extruded on the inner core tube 12.

The reinforcement layer 16 concentrically surrounds the moisture barrier layer 14 and inner core tube 12. The reinforcement layer 14 extends along at least a portion of the moisture barrier layer 14 along the longitudinal axis L of the hose assembly 10. In embodiments of the hose assembly that omit the moisture barrier layer 14, the inner liner layer 18 may extend along at least a portion of the inner core tube 12.

The reinforcement layer 16 is formed of a braid of strands 17. The strands 17 may be formed of any suitable material. In some embodiments, the strands are made of a natural or synthetic polymeric material such as nylon, cotton, polyester, polyamide, aramid, para-aramid, polyolefin, polyvinyl alcohol (PVA), polyvinyl acetate, polyphenylene bezobisoxazole (PBO), and blends thereof. In some embodiments, the strands 17 are metal wires and metal cords made of metal such as steel, such as stainless or galvanized, brass, zinc, zinc-plated wire, and blends thereof. In some embodiments, each strand 72 of the braid is a single fiber. In other embodiments, at least one of the strands 72 of the braid includes two or more fibers.

The braid pattern and design can provide a pitch angle selected for the desired convergence of strength, elongation, weight, and volumetric expansion characteristics of hose assembly 10. An exemplary pitch angle is between about 40° to 65°. Additionally, the tension and area coverage at which the reinforcement layer 16 is braided may be varied to achieve the desired flexibility, which may be measured by bend radius, flexural forces, or the like, of the hose assembly 10. For example, the reinforcement layer 16 shown in FIG. 1 is applied at or near about 100% coverage.

In the exemplary embodiment shown, the braid is provided in a 5 over, 5 under braid pattern. In other embodiments, the braid may be provided in any suitable configuration. For example, some braid patterns have different over under configurations, pitch angles, and/or coverage amounts. It will be appreciated that as an alternative to a braid pattern, the reinforcement layer may instead include a configuration in which one or more strands are wrapped/wound around the moisture barrier layer 14 and inner core tube 12. It will also be appreciated that in other embodiments the hose assembly may include more or fewer reinforcement layers, or a reinforcement layer may be omitted from the assembly.

The reinforcement layers 16 can provide a high-pressure rating to the hose 10. In some embodiments, the burst strength of the hose assembly is at least 2,000 psi. In other embodiments, the burst strength of the hose assembly is at least 5,000 psi. In other embodiments, the burst strength of the hose assembly is at least 10,000 psi. In other embodiments, the burst strength of the hose assembly is 1,000 psi to 10,000 psi. In other embodiments, the burst strength of the hose assembly is at least 2,000 psi to 5,000 psi.

The inner cover layer 18 concentrically surrounds the reinforcement layer 16, moisture barrier layer 14, and inner core tube 12. The inner cover layer 18 may provide a surface to which the thermal distribution element 20 is applied. The inner cover layer 18 extends along at least a portion of the reinforcement layer 16 along the longitudinal axis L of the hose assembly 10. In embodiments of the hose assembly that omit the reinforcement layer 16 and/or that omit the moisture barrier layer 14, the inner cover layer 18 may extend along at least a portion of the immediately adjacent layer that the inner cover layer 18 surrounds (e.g., the moisture barrier layer 14 or the inner core tube 12). The inner cover layer 18 has an inner surface 52 and an outer surface 54.

The inner cover layer 18 may be formed of any suitable material. In some embodiments, the inner cover layer 18 is a thermoplastic (e.g., melt-processible) material such as a polyolefin, polyester, fluoropolymer, polyvinyl chloride, ethylene vinyl alcohol (EVA), polyacetal, polyoxymethylene (POM), silicone, thermoplastic rubber, polyurethane, polyamide, or blends thereof. Exemplary fluoropolymers include polyvinylfluoride (PVF), polyvinylidene fluoride (PVDF), and polytetrafluoroethylene (PTFE). Exemplary polyurethanes include polyether urethane and polyester urethane. Exemplary polyamides include Nylon 6, Nylon 6/66, Nylon 11, Nylon 12, Nylon 1012, Nylon 6/12, or blends thereof. In other embodiments, the inner liner layer 18 is a vulcanizable (e.g., thermosetting) material natural or synthetic rubber. Examples include SBR, polybutadiene, EPDM, butyl, neoprene, nitrile, polyisoprene, buna-N, copolymer rubber, or blends thereof. One exemplary blend is ethylene-propylene rubber. In some embodiments, the inner cover layer 18 is an extruded material and may be formed by a suitable extrusion process.

The thermal distribution element 20 extends along at least a portion of the inner cover layer 18 along the longitudinal axis L of the hose assembly 10. In the exemplary embodiment shown in FIGS. 1 and 2, the thermal distribution element 20 is adjacent the outer surface 54 of the inner cover layer 18. In embodiments of the hose assembly that omit the inner cover layer 18, reinforcement layer 16, and/or the moisture barrier layer 14, the thermal distribution element 20 may extend along at least a portion of and be adjacent the outer surface of the immediately adjacent layer that the thermal distribution element 20 surrounds (e.g., the reinforcement layer 16, the moisture layer 14, or the inner core tube 12).

In the embodiment shown, the thermal distribution element 20 is a tape that is circumferentially wound around the inner cover layer 18 and extends along at least a portion of the inner cover layer 18 along the longitudinal axis L. In embodiments of the hose assembly that omit the inner cover layer 18, reinforcement layer 16, and/or the moisture barrier layer 14, the thermal distribution element 20 may be circumferentially wound around at least a portion of the immediately adjacent layer that the thermal distribution element 20 surrounds (e.g., the reinforcement layer 16, the moisture layer 14, or the inner core tube 12).

In some embodiments, the thermal distribution element 20 is a metalized coated film. The metalized coating may include any suitable metal. Examples include aluminum, copper, gold, silver, platinum, brass, bronze, zinc, and stainless steel. The metalized coated film material may include a substrate on which one or more layers of the metallic coating is applied. In some embodiments, an adhesive is also bonded to a surface of the substrate opposite the surface on which the one or more layers of the metallic coating is applied. In such embodiments, the metalized coated film may also be referred to as a metalized coated tape. In some embodiments, the metalized coated film or tape may be bonded to the surface of the inner cover layer 18 or the immediately adjacent layer that the thermal distribution element 20 surrounds (e.g., the reinforcement layer 16, the moisture layer 14, or the inner core tube 12). The metalized coated film or tape may be bonded by an adhesive.

The thermal distribution element 20 may be wound at a predetermined pitch angle, referenced at 61 in FIG. 1. The thermal distribution element 20 may be provided at any suitable pitch angle (e.g., 1° to 89°). In some embodiments, the pitch angle of the thermal distribution element 20 is 30° to 75°. In other embodiments, the pitch angle of the thermal distribution element 20 is 40° to 65°. As described below, in some embodiments, the heating element has the same pitch angle as the thermal distribution element 20. As such, the larger pitch angle may allow for more heating element length to be provided along the length of the hose assembly 10.

While the embodiment shown in FIG. 1 shows the thermal distribution element 20 as being helically wrapped, in other embodiments, the thermal distribution element 20 is provided in a different arrangement along the longitudinal axis L. For example, in some embodiments (not shown), the metalized coated film is arranged such that its longitudinal axis is parallel to the longitudinal axis L of the tube assembly. That is, one or more lengths of the metalized coated film or tape can be provided with their respective lengths extending parallel to the longitudinal axis. In other embodiments (not shown), the metalized coated film is arranged such that its longitudinal axis is perpendicular to the longitudinal axis L of the tube assembly. That is, one or more lengths of the metalized coated film can be provided with their respective lengths extending perpendicular to the longitudinal axis.

In the embodiment shown in FIG. 1, the thermal distribution element 20 is applied at or near about 100% coverage. For example, the thermal distribution element 20 may applied at at least 95% coverage. In another example, the thermal distribution element 20 may applied at at least 99% coverage. In other embodiments, the thermal distribution element 20 is applied at a lower percentage coverage. In some embodiments, the thermal distribution element 20 is applied in a range of 50% to 100% coverage. In other embodiments, the thermal distribution element 20 is applied in a range of 50% to 90% coverage. In other embodiments, the thermal distribution element 20 is applied in a range of 50% to 80% coverage. In other embodiments, the thermal distribution element 20 is applied in a range of 50% to 70% coverage.

The heating element 22 extends along at least a portion of the length of the hose assembly 10 along the longitudinal axis L of the hose assembly 10. In the exemplary embodiment shown in FIGS. 1 and 2, the heating element 22 concentrically surrounds the thermal distribution element 20.

In an exemplary embodiment, the heating element 22 is an electric wire. FIGS. 1 and 2 schematically show the heating element 22 as a rounded wire. However, the cross-sectional shape of the heating element wire 22 can be provided in any suitable configuration. For example, in some embodiments, the heating element wire 6 may possesses a flat, oval, or other suitable cross-sectional geometry.

In the embodiment shown, the heating element 22 is circumferentially wound around the thermal distribution element 20 and extends along at least a portion of the thermal distribution element 20 along the longitudinal axis L. In the embodiment shown, the heating element 22 may be wound as having a predetermined pitch angle, referenced at 82 in FIG. 1. The heating element 22 may be provided at any suitable pitch angle (e.g., 1° to 89°). In some embodiments, the pitch angle of the heating element 22 is 30° to 75°. In other embodiments, the pitch angle of the heating element 22 20 is 40° to 65°. The pitch angle may allow for more or less heating element to be provided per length of the hose assembly 10.

In some embodiments, the heating element has the same pitch angle as the thermal distribution element 20. In other embodiments, the heating element has a different pitch angle as the thermal distribution element 20. For example, in some embodiments, the thermal distribution element 20 (metalized coated film or tape) is arranged such that its longitudinal axis is parallel or perpendicular to the longitudinal axis L of the tube assembly, while the heating element is circumferentially wound at a predetermined pitch angle 82.

It will also be appreciated that while the embodiment shown in FIG. 1 shows the heating element 22 as being helically wrapped, in other embodiments, the heating element 22 is provided in a different arrangement along the longitudinal axis L. For example, in some embodiments (not shown), the heating element 22 is arranged such that its longitudinal axis is parallel to the longitudinal axis L of the tube assembly. That is, one or more lengths of the heating element 22 can be provided with their respective lengths extending parallel to the longitudinal axis. In other embodiments (not shown), the heating element 22 arranged in a sinusoidal, crenelated, or other suitable pattern along the length of the longitudinal axis L of the hose assembly 10. In such embodiments, the thermal distribution element 20 can be provided at a predetermined pitch angle, or with its longitudinal axis parallel or perpendicular to the longitudinal axis L of the tube assembly.

The heating element 22 is in thermal contact with the thermal distribution element 20. The heating element 22 may include a resistance heating element core, surrounded by an electrical insulator, which is surrounded by an outer (e.g. metal) casing. Accordingly, in some embodiments, the heating element 22 is electrically insulated from the heat distribution element 20. In other embodiments, the heating element 22 is in electrical contact with the heat distribution element 20.

Electric current may be passed through the heating element 22. The heating element 22, generates heat by resistive heating (Joule heating). Generated heat is transferred to the heat distribution element 20 by conduction and dispersed. In some embodiments in which the heat distribution element is in electrical contact with the heat distribution element 20, the heat distribution element may also generate heat.

The generated heat can therefore be more evenly distributed about the length of the hose as compared to simply providing a heating element. The arrangement also allows for less heating element 22 to be used while still maintaining higher consistency of heat throughout the hose. In this manner, temperature variations in the hose such as cold spots in the gaps between wraps of the heating element, are minimized or avoided during operation.

The cover layer 24 concentrically surrounds the heating element 22, thermal distribution element 20, inner cover layer 18, reinforcement layer 16, moisture barrier layer 14, and inner core tube 12. The cover layer 24 extends along at least a portion of the heating element 22 and thermal distribution element 20 along the longitudinal axis L of the hose assembly 10. The cover layer 24 has an inner surface 62 and an outer surface 64.

The cover layer 24 may be formed of any suitable material. In some embodiments, the cover layer 24 is a foamed material. In this manner heat loss to the surrounding environment may be further reduced, which in turn reduces the power required to maintain the desired hose temperature. In some embodiments, the cover layer 24 is a thermoplastic (e.g., melt-processible) material such as a polyolefin, polyester, polyether, fluoropolymer, polyvinyl chloride, ethylene vinyl alcohol (EVA), polyacetal, polyoxymethylene (POM), silicone, thermoplastic rubber, polyurethane, polyamide, or blends thereof. In some embodiments, the is a polyamide, polyurethane, polyester/polyether blend, or blends thereof. Exemplary polyurethanes include polyether urethane and polyester urethane. Exemplary polyamides include Nylon 6, Nylon 6/66, Nylon 11, Nylon 12, Nylon 1012, Nylon 6/12, or blends thereof. In other embodiments, the cover layer 22 is a vulcanizable (e.g., thermosetting) material natural or synthetic rubber. Examples include SBR, polybutadiene, EPDM, butyl, neoprene, nitrile, polyisoprene, buna-N, copolymer rubber, or blends thereof. One exemplary blend is ethylene-propylene rubber. In some embodiments, the cover layer 24 is an extruded material and may be formed by a suitable extrusion process. In such embodiments, a physical or chemical foaming agent can be combined with the material to be extruded to produce a foamed cover layer 24.

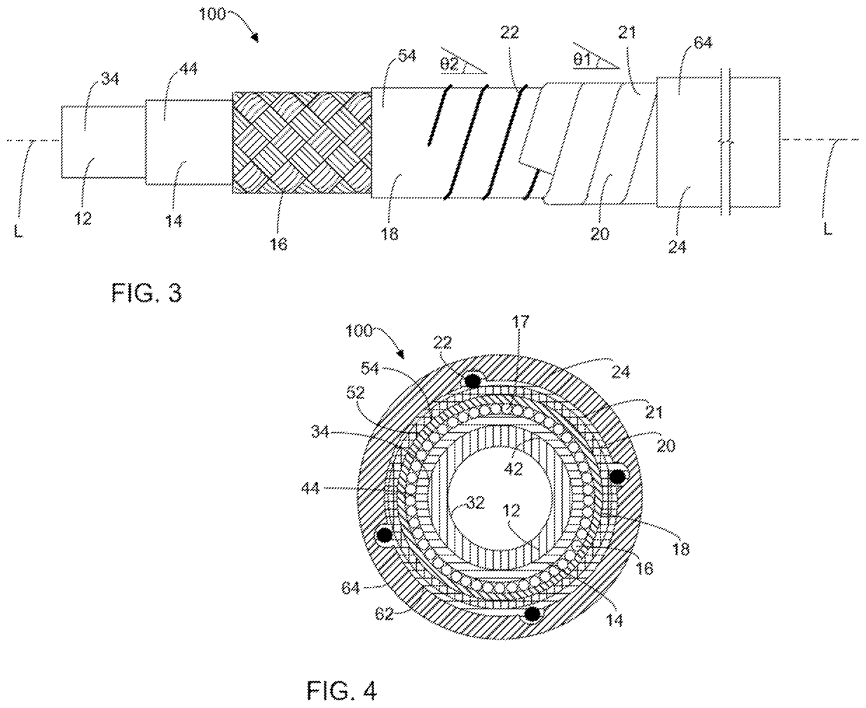

With reference to FIGS. 3 and 4, another embodiment of a hose assembly is shown at 100. The hose assembly 100 is similar to hose assembly 10 shown in FIGS. 1 and 2, but the order in which the heating element 22 and the thermal distribution element 20 are provided in the assembly is reversed. The hose assembly 100 is constructed as a hollow tubular assembly defining a longitudinal axis L and includes an inner core tube 12, a moisture barrier layer 14, a reinforcement layer 16, an inner cover layer 18, a heating element 22, a thermal distribution element 20, and an outer cover layer 24 that are concentrically arranged. The moisture barrier layer 14 surrounds the inner core tube 12; the reinforcement layer 16 surrounds the moisture barrier layer 14; the inner cover layer 18 surrounds the reinforcement layer 16; the heating element 22 surrounds the inner cover layer 18; the thermal distribution element 20 surrounds the heating element 22; and the outer cover layer 24 surrounds the heating element 22. The components of the hose assembly 100, including their materials, construction, and alternative arrangements are described above with respect to hose assembly 10, and will not be repeated for the sake of brevity. It will be appreciated that the reverse order of the heating element 22 and the thermal distribution element 20 can be implemented in any other of the described embodiments.

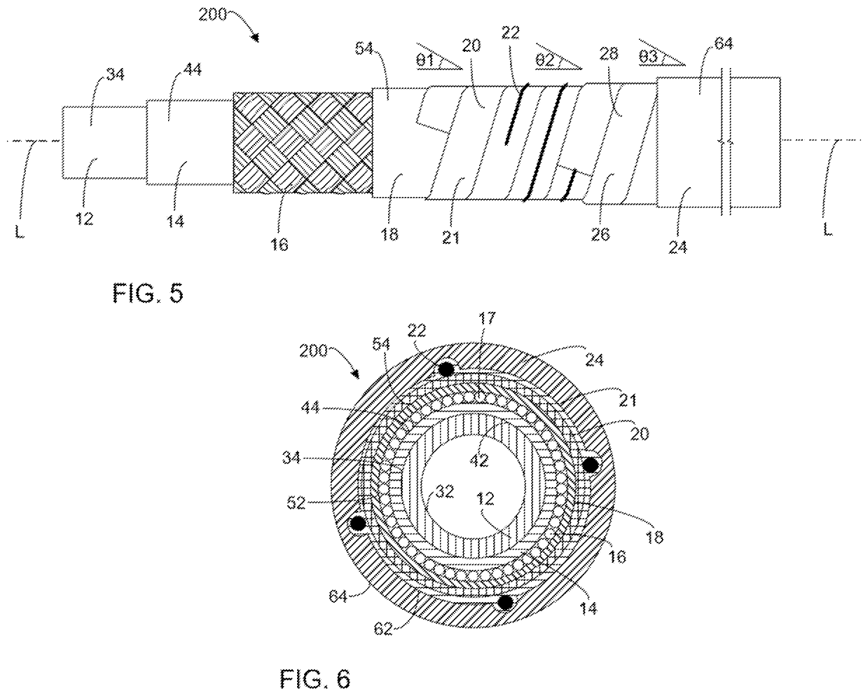

With reference to FIGS. 5 and 6, another embodiment of a hose assembly is shown at 200. The hose assembly 200 is similar to hose assembly 10 shown in FIGS. 1 and 2, but additionally includes an insulation layer 26 circumferentially surrounding the heating element 22. The hose assembly 200 is constructed as a hollow tubular assembly defining a longitudinal axis L and includes an inner core tube 12, a moisture barrier layer 14, a reinforcement layer 16, an inner cover layer 18, a thermal distribution element 20, a heating element 22, an insulation layer 26 and an outer cover layer 24 that are concentrically arranged. The moisture barrier layer 14 surrounds the inner core tube 12; the reinforcement layer 16 surrounds the moisture barrier layer 14; the inner cover layer 18 surrounds the reinforcement layer 16; the heating element 22 surrounds the inner cover layer 18; the thermal distribution element 20 surrounds the heating element 22; and the outer cover layer 24 surrounds the heating element 22. The components of the hose assembly 200, including their materials, construction, and alternative arrangements, are described above in the description with respect to hose assembly 10, and will not be repeated for the sake of brevity. It will be appreciated that the presence of the insulation layer 26 can be implemented in any other of the described embodiments.

The insulation layer 26 concentrically surrounds the heating element 22. In some embodiments, the insulation layer 26 is an insulation film 28. The insulation film 28 may be wound at a predetermined pitch angle, referenced at 83 in FIG. 5. In some embodiments, the insulation film 28 has the same pitch angle as the heating element 22. In other embodiments, the insulation film 28 has a different pitch angle than the heating element 22. The insulation film may, for example, include a metallic (e.g., aluminum), fiberglass, or polymeric layer. The insulation film may reflect heat generated by the heating element toward the inner core tube 12, thereby reducing heat loss and increasing thermal efficiency. In some embodiments, the insulation film 28 comprises an adhesive. The insulation film may also be referred to as an insulation tape.

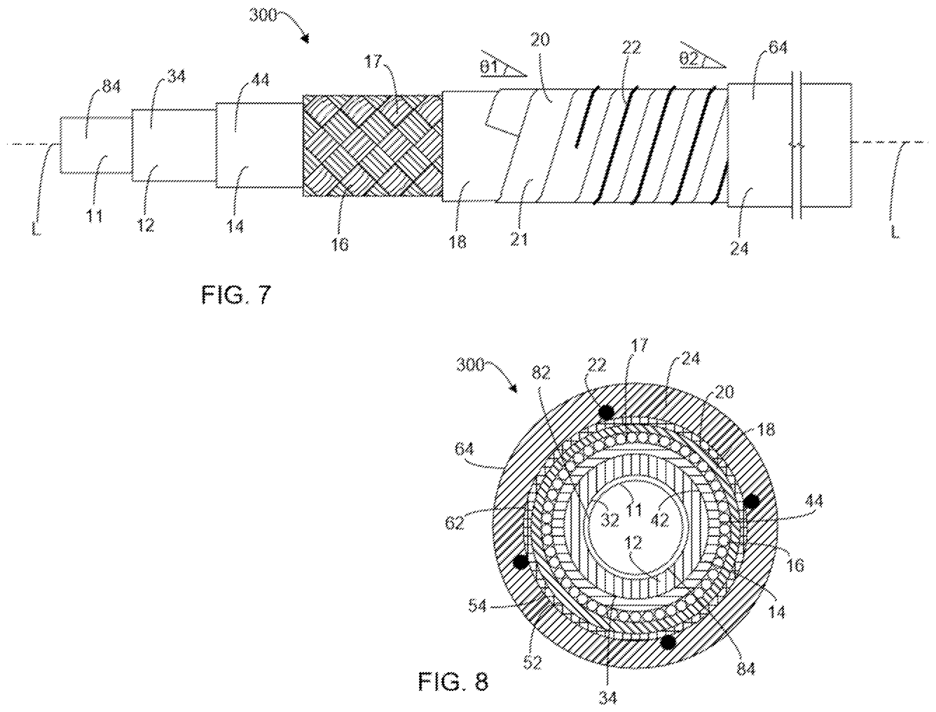

With reference to FIGS. 7 and 8, another embodiment of a hose assembly is shown at 300. The hose assembly 300 is similar to hose assembly 10 shown in FIGS. 1 and 2, but the hose additionally includes a fluoropolymer inner liner 11 inside the inner core tube. The hose assembly 300 is constructed as a hollow tubular assembly defining a longitudinal axis L and includes a fluoropolymer inner liner 11, an inner core tube 12, a moisture barrier layer 14, a reinforcement layer 16, an inner cover layer 18, a thermal distribution element 20, a heating element 22, and an outer cover layer 24 that are concentrically arranged. The inner core tube 12 surrounds the fluoropolymer inner liner 11; the moisture barrier layer 14 surrounds the inner core tube 12; the reinforcement layer 16 surrounds the moisture barrier layer 14; the inner cover layer 18 surrounds the reinforcement layer 16; the thermal distribution element 20 surrounds the inner cover layer 18; the heating element 22 surrounds the thermal distribution element 20; and the outer cover layer 24 surrounds the heating element 22. The components of the hose assembly 100, including their materials, construction, and alternative arrangements are described above with respect to hose assembly 10, and will not be repeated for the sake of brevity. It will be appreciated that the presence of the fluoropolymer inner liner 11 can be implemented in any other of the described embodiments.

The fluoropolymer inner liner 11 may be made of any suitable fluoropolymer material. Exemplary fluoropolymers include polyvinylfluoride (PVF), polyvinylidene fluoride (PVDF), and polytetrafluoroethylene (PTFE). In some embodiments, the fluoropolymer inner liner 11 is an extruded material and may be formed by a suitable extrusion process. The fluoropolymer inner liner 11 has an inner surface 82 and an outer surface 84. In the embodiment shown, the inner surface 32 defines the inner diameter of the hose assembly 10.

The wall of the fluoropolymer inner liner 11 may have any suitable thickness. The thickness is the distance between the inner surface 82 and the outer surface 84 of the fluoropolymer inner liner 11 in a radial direction. In some embodiments, the wall thickness is 0.05 mm to 2 mm. In other embodiments, the wall thickness is 0.5 mm to 1 mm. In other embodiments, the wall thickness is 0.6 mm to 0.9 mm.

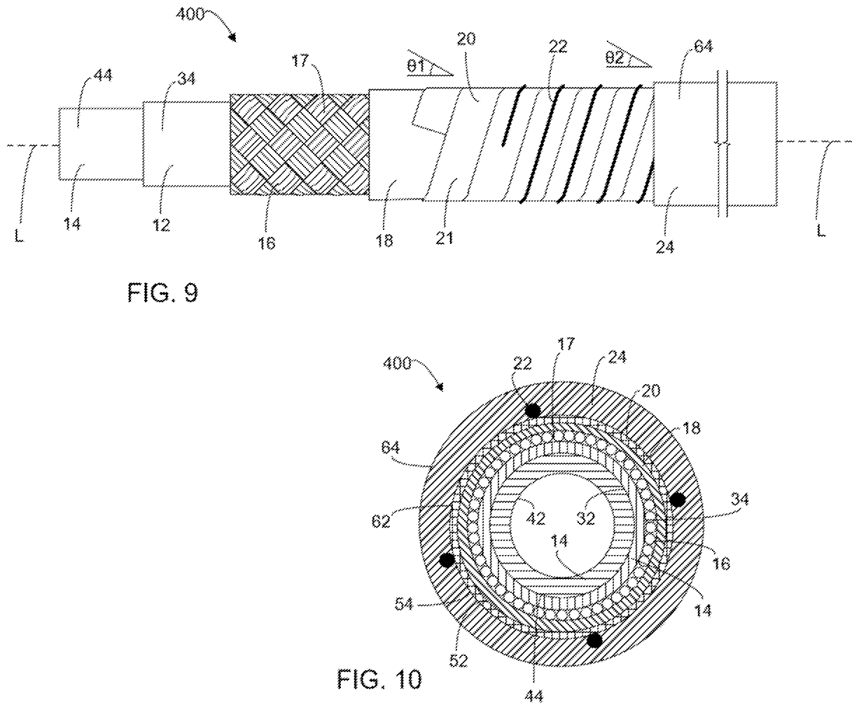

With reference to FIGS. 9 and 10, another embodiment of a hose assembly is shown at 400. The hose assembly 400 is similar to hose assembly 10 shown in FIGS. 1 and 2, but the order in which the moisture barrier layer 14 and the inner core tube 12 are provided in the assembly is reversed. The hose assembly 400 is constructed as a hollow tubular assembly defining a longitudinal axis L and includes a moisture barrier layer 14, an inner core tube 12, a reinforcement layer 16, an inner cover layer 18, a heating element 22, a thermal distribution element 20, and an outer cover layer 24 that are concentrically arranged. The inner core tube 12 surrounds the moisture barrier layer 14; the reinforcement layer 16 surrounds the inner core tube 12; the inner cover layer 18 surrounds the reinforcement layer 16; the heating element 22 surrounds the inner cover layer 18; the thermal distribution element 20 surrounds the heating element 22; and the outer cover layer 24 surrounds the heating element 22. In the embodiment shown, the inner surface 42 of the moisture barrier layer 42 defines the inner diameter of the hose assembly 400. The components of the hose assembly 400, including their materials, construction, and alternative arrangements are described above with respect to hose assembly 10, and will not be repeated for the sake of brevity. It will be appreciated that the reverse order of the moisture barrier layer 14 and the inner core tube 12 can be implemented in any other of the described embodiments.

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A hose assembly, the hose assembly defining a longitudinal axis and comprising:
an inner core tube;
a thermal distribution element surrounding the inner core tube, the thermal distribution element comprising a metalized coated film; and
a heating element surrounding the inner core tube, the heating element in thermal contact with the metalized coated film.

2. The hose assembly of claim 1, wherein the heating element surrounds the thermal distribution element.

3. The hose assembly of claim 1, wherein the thermal distribution element surrounds the heating element.

4. The hose assembly of claim 1, further comprising a moisture barrier layer surrounding the inner core tube, wherein the thermal distribution element and the heating element surround the moisture barrier layer.

5. The hose assembly of claim 4, wherein the hollow tubular core comprises a polyamide.

6. The hose assembly of claim 4, wherein the moisture barrier layer comprises a polyolefin.

7. The hose assembly of claim 4, wherein the moisture barrier layer comprises a polyolefin modified with maleic anhydride.

8. The hose assembly of claim 4, wherein the moisture barrier layer comprises more than one layer.

9. The hose assembly of claim 1, further comprising a reinforcement layer surrounding the inner core tube, the reinforcement layer formed of a braid of strands.

10. The hose assembly of claim 9, further comprising an inner core layer surrounding the reinforcement layer.

11. The hose assembly of claim 1, wherein the metalized coated film is helically wound along the longitudinal axis.

12. The hose assembly of claim 11, wherein the metalized coated film is helically wound at a pitch angle of 30° to 75° relative to the longitudinal axis.

13. The hose assembly of claim 1, wherein the metalized coated film comprises a substrate and a metal coating on a surface of the substrate.

14. The hose assembly of claim 13, wherein the metalized coated film comprises an adhesive.

15. The hose assembly of claim 1, wherein the heating element comprises a wire, wherein the heating element is helically wound along the longitudinal axis.

16. The hose assembly of claim 1, further comprising an insulation layer surrounding the thermal distribution element and the heating element, wherein the insulation layer comprises an insulation film helically wound along the longitudinal axis.

17. The hose assembly of claim 16, wherein the insulation film comprises metallic film.

18. The hose assembly of claim 1, further comprising a cover layer surrounding the thermal distribution element and the heating element.

19. The hose assembly of claim 18, wherein the cover layer is a foamed material.

20. The hose assembly of claim 1, further comprising a fluoropolymer inner layer, wherein the inner core tube surrounds the fluoropolymer inner layer.
